(19) United States
(12) Patent Application Publication
(10) Pub. No.: US 2006/0179004 A1
(43) Pub. Date: Aug. 10, 2006

(54) BioMetric PayPoint System

(75) Inventor: Bill A. Fuchs, Alamo, CA (US)

Correspondence Address: INTEGRITY LLC;BILL FUCHS, 2951 ROUNDHILL ROAD, ALAMO, CA, 94507, US

(73) Assignee: Bill A. Fuchs, Alamo, CA (US)

(21) Appl. No.: 11/164,840

(22) Filed: Dec. 7, 2005

(51) Int. Cl. G06Q 99/00

(52) U.S. Cl. 705/64

(57) ABSTRACT

The Biometric Pay-Point system is the future for all financial transactions particularly point of sale transactions (POS). It is more convenient, safer and more secure than using credit cards or cash. It is always available and cannot be stolen, copied or misplaced. This system will totally eliminate all forms of credit card fraud. The system is applicable for the elimination and protection of personal identity theft.

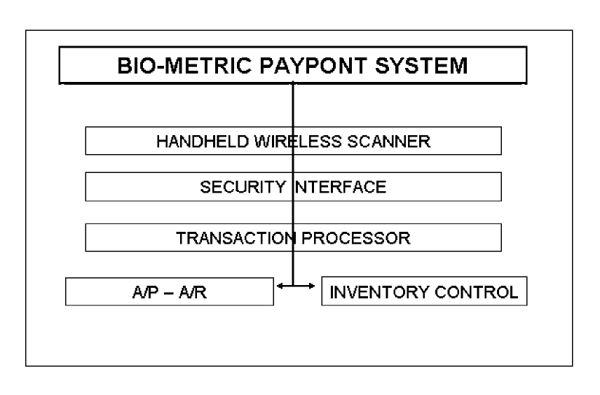

The BioMetric Pay-Point system is a technology and methodology that was developed for the express purpose of making financial transactions of any size and type, easier, more convenient, safer and far more secure.

When coupled with our revolutionary Advanced Ultra Secure Encryption System it forms a truly state-of-the-art complete financial transaction environment.

What is claimed is:

1. The Biometric Pay-Point system is the future for all financial transactions particularly point of sale transactions (pos). It is more convenient, safer and more secure than using credit cards or cash. It is always available and cannot be stolen, copied or misplaced. It is a positive Biometric authorization signature utilizing a finger print and a pin code. The pin code can even be another finger print the order of the fingers prescribes the data stream and proper coding sequence which only the user will know.

2. This system will totally eliminate all forms of credit card fraud. Credit card fraud is a byproduct of having a plastic card, eliminate the card you reduce or eliminate the fraud, cards and cash can be stolen, counterfeited and copied. Fingers are always there never forgotten stolen or misplaced. Credit card fraud statistics vary but are in the multiple billions of dollars annually, moreover the credit and banking industries are reluctant to publish accurate figures.

3. Furthermore, this system is applicable for the elimination and protection of personal identity theft.
